(19) United States
(12) Patent Application Publication
(10) Pub. No.: US 2008/0062180 A1
(43) Pub. Date: Mar. 13, 2008

(54) Character/Graphic Display Apparatus, Character/Graphic Display Method, Program, and Recording Medium

(75) Inventor: Noriyuki Koyama, Kyoto (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 10/556,820

(22) PCT Filed: May 14, 2004
(86) PCT No.: PCT/JP04/06923

§ 371 Date: Sep. 5, 2006

(30) Foreign Application Priority Data
May 15, 2003 (JP) 2003-137918

(51) Int. Cl. G06T 11/00

(52) U.S. Cl. 345/468

(57) ABSTRACT

A character/graphic display apparatus includes a display device for displaying a character or graphic; and a control section for controlling the display device. The control section executes character/graphic display processing, which includes the steps of (a) scaling a character or graphic including reference points along a specific axis so as to generate scaled reference points; (b) quantizing a sum of distances between the scaled reference points by a first method so as to generate a quantized sum; (c) quantizing the distances between the scaled reference points by a second method so as to generate quantized distances; (d) adjusting at least one of the distances quantized by the second method such that a sum of the distances quantized by the second method equals the sum quantized by the first method; and (e) displaying the scaled character or graphic based on the scaled reference points accompanying the at least one adjusted distance.

### TECHNICAL FIELD

The present invention relates to a character/graphic display apparatus, a character/graphic display method, a program, and a recording medium for displaying a scaled character or graphic.

### BACKGROUND ART

Character data for displaying a character is available as, for example, bitmap data and vector data.

Bitmap data includes a fixed coordinate value. A character can be displayed by a display device such as a color liquid crystal display device or the like by outputting the fixed coordinate value to the display device. However, bit map data, which is fixed in accordance with the size of a character, needs to be prepared for each of sizes of required characters.

Vector data includes, for example, data representing an outline of a character or data representing a stroke forming the character. For outputting vector data to a display device such as a color liquid crystal display device or the like, the vector data needs to be scaled in accordance with the size of the character to be displayed by the display device. However, even when a plurality of sizes of characters are required, only one type of vector data is required. The reason is that vector data is not fixed in accordance with the size of a character. Therefore, a smaller capacity of memory device is needed for storing character data.

Vector data is scaled, and then the scaled vector data is quantized by a prescribed method (for example, by round-off; i.e., by rounding up the numeral of 5 or greater and rounding down the numeral of 4 or smaller). As a result, a quantization error is generated. A quantization error is an error between a numeral before data is quantized by a prescribed method and a numeral after the data is quantized by the prescribed method. For example, an error between a pre-round-off numeral, 4.6, and a post-round-off numeral, 5, is 0.4.

FIG. 19 shows strokes obtained before and after coordinate values representing the strokes are rounded off. Figure 19 includes coordinate system A and coordinate system B. Coordinate system A show the strokes before the coordinate values are rounded off, and coordinate system B show the strokes after the coordinate values are rounded off. As a result of rounding off the coordinate values representing the strokes, the distances between the strokes is inverted.

Before the coordinate values are rounded off, the four strokes shown in coordinate system A are represented by coordinate value 0.3 (stroke a), coordinate value 4.5 (stroke b), coordinate value 8.3 (stroke a), and coordinate value 11.5 (stroke d). As a result of rounding off the coordinate values representing the strokes, coordinate value 0.3 (stroke a) becomes coordinate value 0 (stroke a′), coordinate value 4.5 (stroke b) becomes coordinate value 5 (stroke b′), coordinate value 8.3 (stroke c) becomes coordinate value 8 (stroke c′), and coordinate value 11.5 (stroke d) becomes coordinate value 12 (stroke d′).

The distance between stroke a and stroke b (distance ab) is 4.2, the distance between stroke b and stroke c (distance b c) is 3.8, and the distance between stroke c and stroke d (distance cd) is 3.2. As a result of rounding off the coordinate values representing the strokes, the distance between stroke a′ and stroke b′ (distance a′b′) is 5, the distance between stroke b′ and stroke c′ (distance b′c′) is 3, and the distance between stroke c′ and stroke d′ (distance c′d′) is 4.

Before the coordinate values representing the strokes are rounded off, distance ab>distance bc>distance cd. After the coordinate values representing the strokes are rounded off, the relationship is changed to distance a′b′>distance c′d′>distance b′c′. The positions in the order of size of distance bc and distance cd are inverted as a result of rounding off the coordinate values representing the strokes.

A technology for preventing the order of the size from being inverted is disclosed in Japanese Laid-Open Publication No. 6-175638. With reference to FIG. 19, the technology will be described below.

Before rounding off the coordinate values representing the strokes, the distances between the strokes (pre-round-off distances) are found. After rounding off the coordinate values representing the strokes, the distances between the strokes (post-round-off distances) are found. The ratios between the pre-round-off distances and the post-round-off distances are calculated. The strokes are moved such that the difference between the largest ratio and the smallest ratio, among the differences obtained, is minimum.

FIG. 20 shows coordinate system C. The strokes shown in FIG. 20 are obtained by moving the strokes shown in coordinate system A using the technology disclosed in Japanese Laid-Open Publication No. 6-175638.

Specifically, the strokes are moved as follows.

As a result of rounding off the coordinate values representing the strokes, coordinate value 0.3 (stroke a) becomes coordinate value 0 (stroke a′), coordinate value 4.5 (stroke b) becomes coordinate value 5 (stroke b′), coordinate value 8.3 (stroke c) becomes coordinate value 8 (stroke c′), and coordinate value 11.5 (stroke d) becomes coordinate value 12 (stroke d′). The ratios between the post-round-off distances and the pre-round-off distances are: distance a′b′/distance ab=5/4.2=1.19; distance b′c′/distance bc=3/3.8=0.79; and distance c′d′/distance cd=4/3.2=1.25.

The difference between the largest ratio 1.25 (distance c′d′/distance cd) and the smallest ratio 0.79 (distance b′c′/distance bc) is 0.46. In order to minimize the difference between the largest ratio and the smallest ratio, the ratio between a value obtained by subtracting 1 from distance c′d′ and distance cd is found. Such a ratio is 0.94 ((distance c′d′−1)/distance cd=3/3.2=0.94). Again, in order to minimize the difference between the largest ratio and the smallest ratio, the ratio between a value obtained by adding 1 to distance b′c′ and distance bc is found. Such a ratio is 1.05 ((distance b′c′+1)/distance bc=4/3.8=1.05).

As a result, the ratios become ratio 1.19 (distance a′b′/distance ab), ratio 1.05 (distance b′c′+1/distance bc), and ratio 0.94 (distance c′d′−1/distance cd). The difference between the largest ratio 1.19 (distance a′b′/distance ab) and the smallest ratio 0.94 (distance c′d′−1/distance cd) is 0.25. Thus, the difference between the largest ratio and smallest ratio becomes smaller. In order to realize these ratios, the strokes are moved. In this case, stroke c′ is moved away from stroke b′.

FIG. 21 shows coordinate system D and coordinate system E. Coordinate system D show four strokes. Coordinate system E show strokes obtained by moving the strokes shown in coordinate system D using the technology disclosed in Japanese Laid-Open Publication No. 6-175638.

The four strokes shown in coordinate system D are represented by coordinate value 0.2 (stroke a), coordinate value4.4 (stroke b), coordinate value 8.2 (stroke c), and coordinate value 11.4 (stroke d). As a result of rounding of f the coordinate values representing the strokes, coordinate value 0.2 (stroke a) becomes coordinate value 0 (stroke a′), coordinate value 4.4 (stroke b) becomes coordinate value 4 (stroke b′), coordinate value 8.2 (stroke c) becomes coordinate value 8 (stroke c′) and coordinate value 11.4 (stroke d) becomes coordinate value 11 (stroke d′).

The ratios between the post-round-off distances and the pre-round-off distances are: distance a′b′/distance ab=4/4.2=0.95; distance b′c′/distance bc=4/3.8=1.05; and distance c′d′/distance cd=3.2/3.4=0.94. The largest ratio is 1.05 (distance b′c′/distance bc) and the smallest ratio is 0.94 (distance c′d′/distance cd). In order to minimize the difference between the largest ratio and the smallest ratio, the ratio between a value obtained by subtracting 1 from distance b′c′ and distance bc is found. Such a ratio is 0.79 ((distance b′c′−1)/distance bc). Again, in order to minimize the difference between the largest ratio and the smallest ratio, the ratio between a value obtained by adding 1 to distance c′d′ and distance cd is found. Such a ratio is 1.25 ((distance c′d′+1)/distance cd). The difference between the largest ratio and the smallest ratio does not become smaller. Before the coordinate values representing the strokes are rounded off, distance ab>distance bc>distance cd. As a result of rounding off the coordinate values representing the strokes, the relationship of distance a′b′=distance c′d′>distance b′c′ a is obtained. Since the positions in the order of the size of distance ab, distance bc and distance cd are not inverted, the balance in the distances between adjacent strokes is maintained.

The strokes shown in coordinate system C are obtained by moving the strokes shown in coordinate system A using the technology disclosed in Japanese Laid-Open Publication No. 6-175638. The strokes shown in coordinate system E are obtained by moving the strokes shown in coordinate system D using the technology disclosed in Japanese Laid-Open Publication No. 6-175638.

The strokes shown in coordinate system D are obtained by moving the strokes shown in coordinate system A downward by 0.1. Accordingly, the strokes shown in coordinate system D and the strokes shown in coordinate system A have the same shape and size. However, since the strokes shown in coordinate system D and the strokes shown in coordinate system A are shown at different positions, the strokes shown in coordinate system C and the strokes shown in coordinate system E have different shapes and sizes.

Specifically, distance a′d′ between the strokes shown in coordinate system C is 12. Distance a′d′ between the strokes shown in coordinate system E is 11.

FIG. 22 shows coordinate system F and coordinate system G. Coordinate system F show six strokes. Coordinate system G show strokes obtained by moving the stroke shown in coordinate system F using the technology disclosed in Japanese Laid-Open Publication No. 6-175638.

The six strokes shown in coordinate system F are represented by coordinate value 0.3 (stroke a), coordinate value 4.5 (stroke b), coordinate value 8.3 (stroke c), coordinate value 11.5 (stroke d), coordinate value 15.2 (coordinate e), and coordinate value 18.6 (coordinate f). As a result of rounding off the coordinate values representing the strokes, coordinate value 0.3 (stroke a) becomes coordinate value 0 (stroke a′), coordinate value 4.5 (stroke b) becomes coordinate value 5 (stroke b′), coordinate value 8.3 (stroke c) becomes coordinate value 8 (stroke c′), coordinate value 11.5 (stroke d) becomes coordinate value 12 (stroke d′), coordinate value 15.2 (coordinate e) becomes coordinate value 15 (coordinate e′), and coordinate value 18.6 (coordinate f) becomes coordinate value 19 (coordinate f′).

The ratios between the post-round-off distances and the pre-round-off distances are: distance a′b′/distance ab=5/4.2=1.19; distance b′c′/distance bc=3/3.8=0.79; distance c′d′/distance cd=4/3.2=1.25; distance d′e′/distance de=3/3.7=0.81; and distance e′f′/distance ef=4/3.4=1.18. The largest ratio is 1.25 (distance c′d′/distance cd) and the smallest ratio is 0.79 (distance b′c′/distance bc). In order to minimize the difference between the largest ratio and the smallest ratio, the ratio between a value obtained by subtracting 1 from distance c′d′ and distance cd is found. Such a ratio is 0.94 ((distance c′d′−1)/distance cd). Again, in order to minimize the difference between the largest ratio and the smallest ratio, the ratio between a value obtained by adding 1 to distance b′c′ and distance bc is found. Such a ratio is 1.05 ((distance b′c′+1)/distance bc).

Since the difference between the largest ratio and the smallest ratio becomes smaller, stroke c′ is moved toward stroke b′. Although some of the distances between the strokes shown in coordinate system G are corrected, distance de and distance ef are still inverted.

FIG. 23 shows coordinate system H, coordinate system I, and coordinate system J. Coordinate system H show two strokes. Coordinate system I show strokes obtained by rounding off the coordinate values representing the strokes shown in coordinate system H. Coordinate system J show strokes displayed by a display device.

The two strokes shown in coordinate system H are represented by coordinate value 0.6 (stroke a) and coordinate value 2.4 (stroke b). As a result of rounding off the coordinate values representing the strokes, coordinate value 0.6 (stroke a) becomes coordinate value 1 (stroke a′), and coordinate value 2.4 (stroke b) becomes coordinate value 2 (stroke b′).

There is only one distance between the two strokes, the strokes cannot be moved using the technology disclosed in Japanese Laid-Open Publication No. 6-175638. In the case where drawing data is generated from the data on the strokes shown in coordinate system I and is displayed by the display device, the two strokes appears crushed.

As described above, movement of strokes using the technology disclosed in Japanese Laid-Open Publication No. 6-175638 involves the following problems (1) through (3).

(1) The strokes shown in coordinate system D and coordinate system A have the same shape and the same size. However, after the positions of the strokes are adjusted using the technology disclosed in Japanese Laid-Open Publication No. 6-175638, the post-adjustment strokes shown in coordinate system E and the pre-adjustment strokes shown in coordinate system C have different shapes and different sizes.

(2) Although some of the distances between the strokes shown in coordinate system G are corrected, distance de and distance ef are still inverted. Thus, all the distances between the strokes have not been corrected. Therefore, the balance of strokes before the adjustment of the positions of the strokes cannot be maintained after the positions of the strokes are adjusted.

(3) As a result of adjusting the positions of the strokes, two parallel strokes are in contact with each other and thus crushed. As a result, the two strokes appear to be one stroke.

The present invention has an objective of providing a character/graphic display apparatus, a character/graphic display method, a program, and a recording medium for solving at least one of the problems (1) through (3).

### DISCLOSURE OF THE INVENTION

A character/graphic display apparatus according to the present invention includes a display device for displaying a character or graphic; and a control section for controlling the display device. The control section executes character/graphic display processing. The character/graphic display processing includes the steps of (a) scaling a character or graphic including reference points along a specific axis so as to generate scaled reference points; (b) quantizing a sum of distances between the scaled reference points by a first method so as to generate a sum quantized by the first method; (c) quantizing the distances between the scaled reference points by a second method so as to generate distances quantized by the second method; (d) adjusting at least one of the distances quantized by the second method such that a sum of the distances quantized by the second method equals the sum quantized by the first method; and (e) displaying the scaled character or graphic based on the scaled reference points accompanying the at least one adjusted distance. By this, the above-described objective is achieved.

The quantization by the second method may be performed in consideration of a distance flag representing a minimum necessary distance as a distance quantized by the second method.

Step (d) may be performed in consideration of a distance flag representing a minimum necessary distance as a distance quantized by the second method.

Step (d) may include the step of extending at least one of the distances quantized by the second method.

Step (d) may include the step of shortening at least one of the distances quantized by the second method.

Step (d) may include the step of making at least one of the distances quantized by the second -method zero.

Step (e) may include the step of displaying a first point which is a prescribed point on the scaled character, such that a value of distance a/distance b is closest to a value of distance A/distance B, where: a second point which corresponds to the first point and is on the pre-scaling character is between a first reference point and a second reference point adjacent to each other, among the pre-scaling reference points; distance A is a distance between the second point and the first reference point; distance B is a distance between the second point and the second reference point; distance a is between the first point and the scaled first reference point; and distance b is between the first point and the scaled second reference point.

The character may be formed of a plurality of blocks. The character/graphic display processing may further include the step of executing steps (b) through (d) for each of the plurality of blocks.

The step of making at least one of the distances quantized by the second method zero may be performed in consideration of a flag which represents a position of a distance to be made zero in the order by which the at least one of the distances is made zero.

A character/graphic display method according to the present invention includes the steps of scaling a character or graphic including reference points along a specific axis so as to generate scaled reference points; quantizing a sum of distances between the scaled reference points by a first method so as to generate a sum quantized by the first method; quantizing the distances between the scaled reference points by a second method so as to generate distances quantized by the second method; adjusting at least one of the distances quantized by the second method such that a sum of the distances quantized by the second method equals the sum quantized by the first method; and displaying the scaled character or graphic based on the scaled reference points accompanying the at least one adjusted distance. By this, the above-described objective is achieved.

A program, according to the present invention, for having a character/graphic display apparatus, including a display device for displaying a character or graphic and a controlling section for controlling the display device, to execute character/graphic display processing, the character/graphic display processing includes the steps of scaling a character or graphic including reference points along a specific axis so as to generate scaled reference points; quantizing a sum of distances between the scaled reference points by a first method so as to generate a sum quantized by the first method; quantizing the distances between the scaled reference points by a second method so as to generate distances quantized by the second method; adjusting at least one of the distances quantized by the second method such that a sum of the distances quantized by the second method equals the sum quantized by the first method; and displaying the scaled character or graphic based on the scaled reference points accompanying the at least one adjusted distance. By this, the above-described objective is achieved.

A recording medium, according to the present invention, readable by a character/graphic display apparatus, including a display device for displaying a character or graphic and a controlling section for controlling the display device, has a program for having the control section to execute character/graphic display processing which includes the steps of scaling a character or graphic including reference points along a specific axis so as to generate scaled reference points; quantizing a sum of distances between the scaled reference points by a first method so as to generate a sum quantized by the first method; quantizing the distances between the scaled reference points by a second method so as to generate distances quantized by the second method; adjusting at least one of the distances quantized by the second method such that a sum of the distances quantized by the second method equals the sum quantized by the first method; and displaying the scaled character or graphic based on the scaled reference points accompanying the at least one adjusted distance. By this, the above-described objective is achieved.

### BRIEF DESCRIPTION OF THE DRAWINGS

FIG. 1 shows a structure of a character display apparatus 100 according to an example of the present invention.

FIG. 2 shows strokes of character

[symbol]

FIG. 3 shows character data 142 formed of the strokes shown in FIG. 2.

FIG. 4 shows character data of character

[symbol]

FIG. 5 shows distances between reference points in a Y-axis direction, and distances between reference points in an X-axis direction.

FIG. 6 is a flowchart illustrating a processing procedure of a character display program 141.

FIG. 7 is a flowchart illustrating a processing of procedure of grid fitting (program 141b) performed in step S103.

FIG. 8 is a flowchart illustrating a detailed processing procedure on a block along a specific axis performed in steps S201 and S203.

FIG. 9 shows pre-scaling coordinate data and post-scaling coordinate data.

FIG. 10 shows data obtained by grid-fitting character data in the Y-axis direction.

FIG. 11 shows coordinate values after grid fitting.

FIG. 12 shows data obtained by grid-fitting character data in the X-axis direction.

FIG. 13 shows character [symbol] of the size of 30 dots displayed by the display device.

FIG. 14 shows pre-scaling coordinate data and post-scaling coordinate data.

FIG. 15 shows data obtained by grid-fitting character data in the Y-axis direction.

FIG. 16 shows coordinate values after grid fitting.

FIG. 17 shows data obtained by grid-fitting character data in the X-axis direction.

FIG. 18 shows character [symbol] of the size of 14 dots displayed by the display device.

FIG. 19 shows strokes before and after coordinate values representing the strokes are round-off.

FIG. 20 shows coordinate system C.

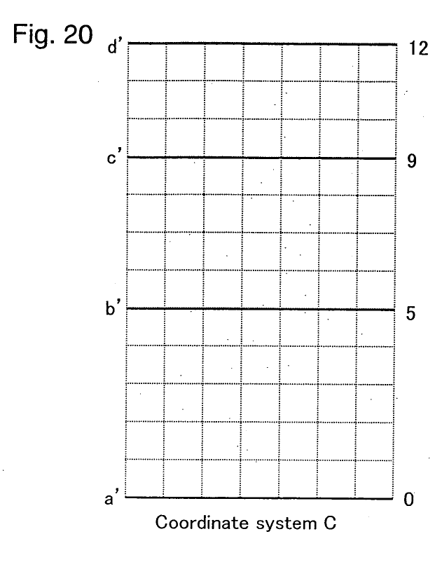

FIG. 21 shows coordinate system D and coordinate system E.

FIG. 22 shows coordinate system F and coordinate system G.

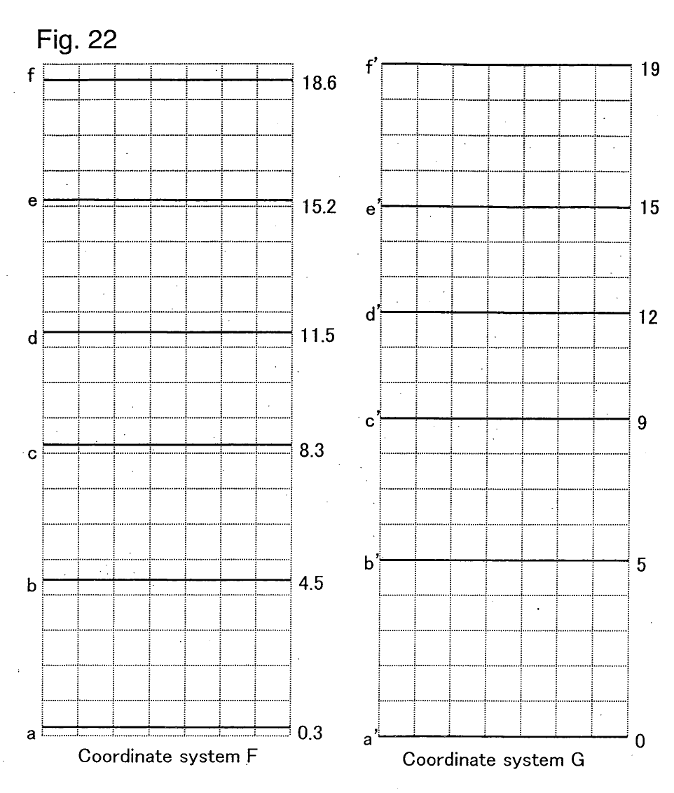

FIG. 23 shows coordinate system H, coordinate system I, and coordinate system J.

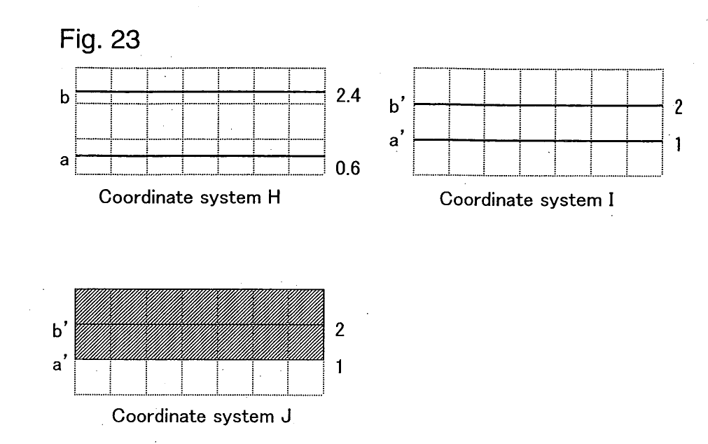

### BEST MODE FOR CARRYING OUT THE INVENTION

Herein, “characters” include, for example, “hiragana” Japanese phonetic letters, “katakana” Japanese phonetic letters, Chinese characters, alphabets, pictographs, and numerals, but are not limited to these.

Herein, the “graphics” include, for example, part of characters, patterns, and symbols, but are not limited to these.

Hereinafter, the present invention will be described by way of examples with reference to the drawings.

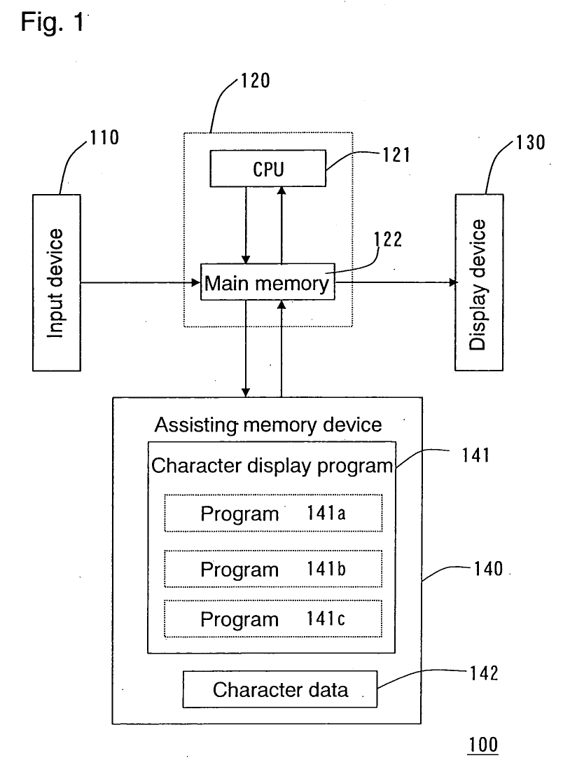

FIG. 1 shows a structure of a character display apparatus 100 according to an example of the present invention. The character display apparatus 100 may be, for example, a personal computer. As a personal computer, a desk-top, lap-top, or any other type of computer may be used. The character display apparatus 100 may be a word processor.

The character display apparatus 100 may be any information display apparatus such as, for example, an electronic device or an information device including a display device. For example, the character display apparatus 100 may be an electronic device, a mobile information terminal used as a mobile information tool, a cellular phone or a PHS terminal, or a communication device such as a general telephone/facsimile machine, which includes a liquid display device.

The character display apparatus 100 includes an input device 110, a display device 130 for displaying characters, a controlling section 120 for controlling the display device 130, and an assisting memory device 140. The control section 120 is connected to the input device 120, the display device 130 and the assisting memory device 140.

The input device 110 is used for inputting, to the display device 130, character information, which represents a character to be displayed by the display device 130. The character information include, for example, a character code for identifying a character and size information representing the size of a character. The input device 110 may be of any type which is capable of inputting a character code and size information. For example, an input device such as a keyboard, a mouse, a pen input device or the like is preferably usable as the input device 110.

In the case where the character display apparatus 100 is a cellular phone, numeral keys for designating telephone numbers of parties to be called may be used for inputting a character code or size information. In the case where the character display apparatus 100 includes means for connection with a telephone communication line including the Internet, messages included in electronic mails received through the telephone line may be displayed by the display device 130. In such a case, the means for connection acts as the input device 100.

The assisting memory device 140 stores a character display program 141 and character data 142 necessary for executing the character display program 141. The character data 142 includes coordinate data.

The character display program 141 includes a program 141a for scaling coordinate data included in the character data 142 such that the coordinate data matches the character size to be output to the display device 130 and thus generating the scaled coordinate data, a program 141b for grid-fitting the scaled coordinate data and thus generating the grid-fitted coordinate data, and a drawing data generation program 141c for generating drawing data displayable by the display device 130 based on the grid-fitted coordinate data.

The functions of the programs 141a through 141c will be described in detail later.

The character data 142 is, for example, vector data. In this example, vector data has a 256-mesh resolution. However, the resolution of vector data is not limited to 256-mesh, and may be 32-mesh or 14-mesh.

The assisting memory device 140 may be of any type which is capable of storing the character display program 141 and the character data 142. The assisting memory device 140 uses any type of recording medium for storing the character display program 141 and the character data 142. For example, a recording medium such as a hard disc, CD-ROM, MO, MD, DVD, IC card, optical card or the like is preferably used.

The character display program 141 and the character data 142 are not limited to being stored in the recording medium included in the assisting memory device 140. For example, the character display program 141 and the character data 142 may be stored in a main memory 122 included in the control section 120 or in a ROM (not shown). The ROM may be, for example, a mask ROM, an EPROM, an EEPROM, or a flash ROM. In the case of a ROM system of storing information in a ROM, various types of processing can be realized simply by exchanging ROMs. The ROM system is preferably applicable when, for example, the character display apparatus 100 is a mobile terminal or a cellular phone.

The recording medium for storing the character display program 141 and the character data 142 may be a medium such as a disc, card, other memory devices or a semiconductor memory, for fixedly carrying a program or data. Alternatively, the recording medium may be a medium for fluidly carrying a program or data, for example, a communication medium used for carrying a program or data in a communication network. In the case where the character display apparatus 100 includes means for connection with a telephone communication line including the Internet, at least a part of the character display program 141 and the character data 142 can be downloaded from the telephone communication line. In this case, a loader program necessary for downloading may be pre-stored in the ROM (not shown) or installed into the control section 120 from the assisting memory device 140.

The control section 120 includes a CPU 121 and the main memory 122.

The CPU 121 controls and monitors the entirety of the character display apparatus 100 and executes the character display program 141 stored in the assisting memory device 140.

The main memory 122 temporarily stores data which has been input to the main memory 122 from the input device 110, data to be displayed by the display device 130, and data necessary for executing the character display program 141. The main memory 122 is controlled by the CPU 121.

The CPU 121 executes the character display program 141 based on various data stored in the main memory 122 to generate drawing data. The generated drawing data is once stored in the main memory 122 and then output to the display device 130. The timing for outputting the drawing data to the display device 130 is controlled by the CPU 121.

The display device 130 is, for example, a color liquid crystal display device. As the color liquid crystal display device, a transmissive liquid crystal display device widely used for personal computers, a reflective liquid crystal display device, or a rear projection type liquid crystal display device is usable. The display device 130 is not limited to a color liquid crystal display device. Any color display device having a plurality of pixels arranged in X and Y-axis directions (so-called XY matrix display device) is usable as the display device 130.

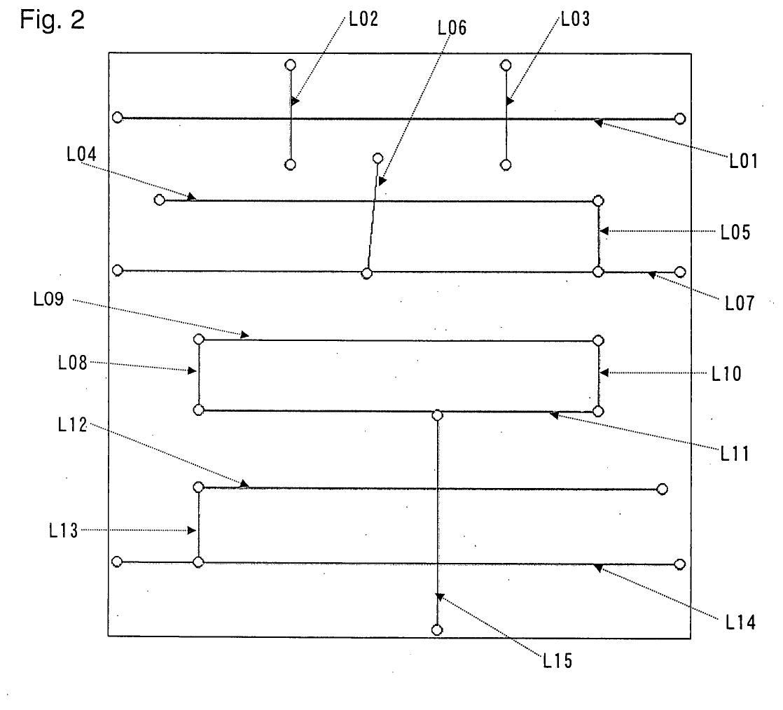

FIG. 2 shows strokes forming character [symbol] Character [symbol] is formed of 15 strokes represented by strokes L01 through L15.

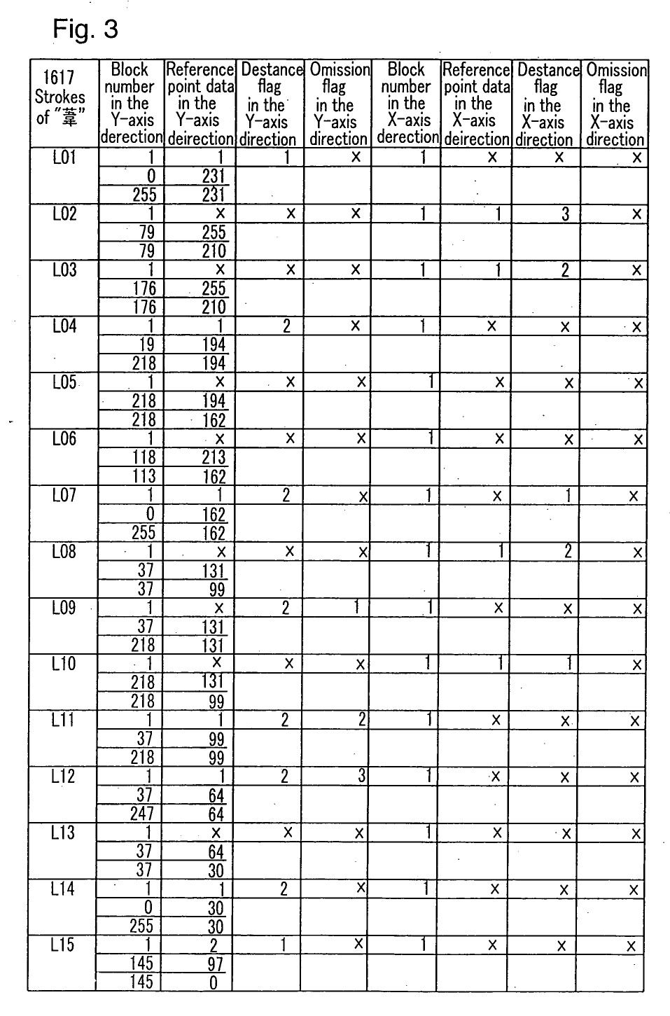

FIG. 3 shows the character data 142 on character

[symbol]

As shown in FIG. 3, the character data 142 on character [symbol] includes coordinate data, Y-axis direction block number, X-axis direction block number, Y-axis direction reference point data, X-axis direction reference point data, Y-axis direction distance flag, X-axis direction distance flag, Y-axis direction omission flag, and X-axis direction omission flag for each of strokes L01 through L15.

Hereinafter, the coordinate data, Y-axis direction block number, X-axis direction block number, Y-axis direction reference point data, X-axis direction reference point data, Y-axis direction distance flag, X-axis direction distance flag, Y-axis direction omission flag, and X-axis direction omission flag shown in FIG. 3 will be described.

Coordinate data represents a point on a stroke. Coordinate data includes a set of an X coordinate value and a Y coordinate value. Coordinate data may include a plurality of sets of an X coordinate value and a Y coordinate value. Strokes L01 through L15 are each represented by coordinate data including two sets of an X coordinate value and a Y coordinate value. An X coordinate value is one of values 0 through 255. A Y coordinate value is one of values 0 through 255.

Stroke L01 is a straight line connecting a first point of the coordinate data (0, 231) and a second point of the coordinate data (255, 231). Stroke L02 is a straight line connecting a first point of the coordinate data (79, 255) and a second point of the coordinate data (79, 210). Stroke L03 is a straight line connecting a first point of the coordinate data (176, 255) and a second point of the coordinate data (176, 210). Stroke L04 is a straight line connecting a first point of the coordinate data (19, 194) and a second point of the coordinate data (218, 194). Stroke L05 is a straight line connecting a first point of the coordinate data (218, 194) and a second point of the coordinate data (218, 162). Stroke L06 is a straight line connecting a first point of the coordinate data (118, 213) and a second point of the coordinate data (113, 162). Stroke L07 is a straight line connecting a first point of the coordinate data (0, 162) and a second point of the coordinate data (255, 162). Stroke L08 is a straight line connecting a first point of the coordinate data (37, 131) and a second point of the coordinate data (37, 99). Stroke L09 is a straight line connecting a first point of the coordinate data (37, 131) and a second point of the coordinate data (218, 131). Stroke L10 is a straight line connecting a first point of the coordinate data (218, 131) and a second point of the coordinate data (218, 99). Stroke L11 is a straight line connecting a first point of the coordinate data (37, 99) and a second point of the coordinate data (218, 99). Stroke L12 is a straight line connecting a first point of the coordinate data (37, 64) and a second point of the coordinate data (247, 64). Stroke L13 is a straight line connecting a first point of the coordinate data (37, 64) and a second point of the coordinate data (37, 30). Stroke L14 is a straight line connecting a first point of the coordinate data (0, 30) and a second point of the coordinate data (255, 30). Stroke L15 is a straight line connecting a first point of the coordinate data (145, 97) and a second point of the coordinate data (145, 0).

A block number represents the number of a block forming a character. One block includes a radical or a part of the character. A character is not necessarily formed of a plurality of blocks. A character may be formed of one block. As shown in FIG. 3, the Y axis block number is 1 for all the strokes, and the X-axis block number is 1 for all the strokes. This indicates that the character [symbol] is formed of one block.

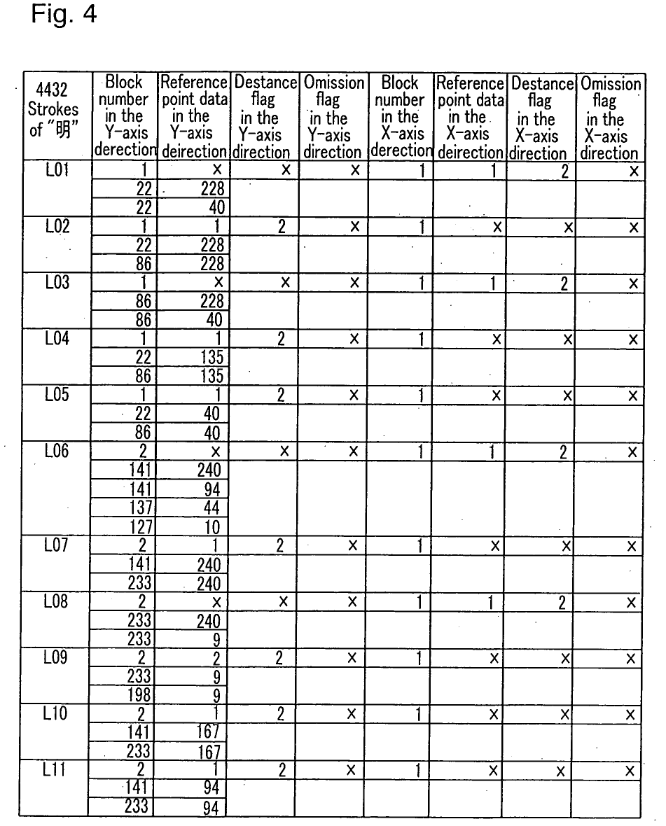

FIG. 4 shows character data on character [symbol] ”.

With reference to FIG. 4, a character including a plurality of blocks will be described.

As shown in FIG. 4, the Y-axis block number of each of strokes L01 through L05 is 1. The Y-axis block number of each of strokes L06 through L11 is 2. The X-axis block number is 1 for all the strokes. This indicates that the character [symbol] is formed of two blocks. The left-hand radical [symbol] is formed of the first block. The right-hand radical [symbol] is formed of the second block.

With reference to FIG. 4, a character including a plurality of blocks has been described.

Again, with reference to FIG. 3, data included in character data 142 will be described.

Reference point data represents whether a stroke includes a reference point or not. When the stroke includes a reference point, the reference point data indicates the position of the reference point in the coordinate data.

Reference point data indicating whether the stroke L01 includes a Y-axis direction reference point or not is 1. This indicates that stroke L01 includes a Y-axis direction reference point and that the reference point of stroke L01 is the first point in the coordinate data (0, 231).

Similarly, reference point data indicating whether each of strokes L04, L07, L09, L11, L12 and L14 includes a Y-axis direction reference point or not is 1. The reference point of stroke L04 is the first point in the coordinate data (19, 194). The reference point of stroke L07 is the first point in the coordinate data (0, 162). The reference point of stroke L09 is the first point in the coordinate data (37, 131). The reference point of stroke L11 is the first point in the coordinate data (13, 99). The reference point of stroke L12 is the first point in the coordinate data (37, 64). The reference point of stroke L14 is the first point in the coordinate data (0, 30).

Reference point data indicating whether stroke L02 includes a Y-axis direction reference point or not is x. This indicates that stroke L02 does not include a Y-axis direction reference point.

Similarly, reference point data indicating whether each of strokes L03, L05, L06, L08, L10 and L13 includes a Y-axis direction reference point or not is x. This indicates that none of strokes L03, L05, L06, L08, L10 and L13 include a Y-axis direction reference point.

Reference point data indicating whether stroke L15 includes a Y-axis direction reference point or not is 2. This indicates that stroke L15 includes a Y-axis direction reference point and that the reference point of stroke L15 is the second point in the coordinate data (145, 0).

Reference point data indicating whether each of strokes L0, L04, L05, L06, L07, L09 and L11 through L15 includes an X-axis direction reference point or not is x. This indicates that none of strokes L0, L04, L05, L06, L07, L09 and L11 through L15 include an X-axis direction reference point.

Reference point data indicating whether each of strokes L02, L03, L08 and L10 includes an X-axis direction reference point or not is 1. The reference point of stroke L02 is the first point in the coordinate data (79, 255). The reference point of stroke L03 is the first point in the coordinate data (176, 255). The reference point of stroke L08 is the first point in the coordinate data (37, 131). The reference point of stroke L10 is the first point in the coordinate data (218, 131).

A reference point is a point included in a block forming a character. A reference point can be set on a stroke extending in the X-axis direction as well as on a stroke extending in the Y-axis direction. For example, the reference point of stroke L15 extending in the Y-axis direction is the second point of the coordinate data.

A reference point is not necessarily set on a stroke extending in the Y-axis direction or on a stroke extending in the X-axis direction.

For example, a reference point may be a point not on a stroke. A reference point may be inherently given in accordance with the type of the character or may be obtained by calculating the character data 142.

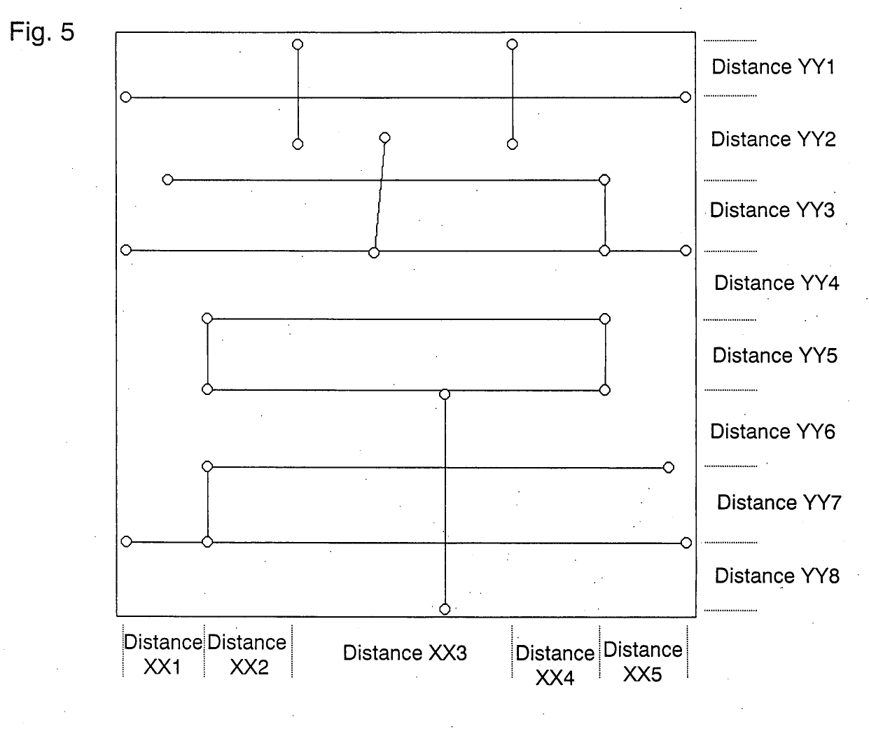

FIG. 5 shows distances between reference points in the Y-axis direction and distances between reference points in the X-axis direction.

FIG. 5 shows eight distances between the reference points in the Y-axis direction. These eight distances are represented by distance YY1, distance YY2, distance YY3, distance YY4, distance YY5, distance YY6, distance YY7, and distance YY8.

Distance YY1 is distance 24 between the reference point (0, 231) in the Y-axis direction and the point of the maximum Y coordinate (0, 255). Distance YY2 is distance 37 between the reference point (0, 194) in the Y-axis direction and the reference point (0, 231) in the Y-axis direction. Distance YY3 is distance 32 between the reference point (0, 162) in the Y-axis direction and the reference point (0, 194) in the Y-axis direction. Distance YY4 is distance 31 between the reference point (0, 131) in the Y-axis direction and the reference point (0, 162) in the Y-axis direction. Distance YY5 is distance 32 between the reference point (0, 99) in the Y-axis direction and the reference point (0, 131) in the Y-axis direction. Distance YY6 is distance 35 between the reference point (0, 64) in the Y-axis direction and the reference point (0, 99) in the Y-axis direction. Distance YY7 is distance 34 between the reference point (0, 30) in the Y-axis direction and the reference point (0, 64) in the Y-axis direction. Distance YY8 is distance 30 between the point of the minimum Y coordinate (0, 0) and the reference point (0, 30) in the Y-axis direction.

FIG. 5 shows five distances between the reference points in the X-axis direction. These five distances are represented by distance XX1, distance XX2, distance XX3, distance XX4, and distance XX5.

Distance XX1 is distance 37 between the point of the minimum X coordinate (0, 0) and the reference point (37, 0) in the X direction. Distance XX2 is distance 42 between the reference point (79, 0) in the X-axis direction and the reference point (37, 0) in the X-axis direction. Distance XX3 is distance 97 between the reference point (716, 0) in the X-axis direction and the reference point (79, 0)in the X-axis direction. Distance XX4 is distance 42 between the reference point (218, 0) in the X-axis direction and the reference point (176, 0) in the X-axis direction. Distance XX5 is distance 37 between the point of the maximum X coordinate (255, 0) and the reference point (218, 0) in the X-axis direction.

A distance flag represents whether the distance flag has the minimum necessary distance. The distance flag also indicates what the minimum necessary distance is as the distance between reference points along a specific axis. For example, a distance flag may be x. This indicates that the distance flag does not have the minimum necessary distance. For example, a distance flag may be numeral M. This indicates that the distance flag has the minimum necessary distance, and that the distance flag requires the minimum necessary distance M as a distance between reference points along a specific axis.

The distance flag of stroke L01 in the Y-axis direction is 1. This indicates that the distance flag of stroke L01 in the Y-axis direction has the minimum necessary distance, and that the distance flag of stroke L01 requires the minimum necessary distance 1 as a distance between reference points in the Y-axis direction.

The distance flag of stroke L02 in the Y-axis direction is x. This indicates that the distance flag of stroke L02 in the Y-axis direction does not have the minimum necessary distance.

Similarly, the distance flag of each of strokes L03, L05, L06, L08, L10 and L13 in the Y-axis direction is x. This indicates that the distance flag of none of strokes L03, L05, L06, L08, L10 and L13 in the Y-axis direction have the minimum necessary distance.

The distance flag of stroke L04 in the Y-axis direction is 2. This indicates that the distance flag of stroke L04 in the Y-axis direction has the minimum necessary distance, and that the distance flag of stroke L04 requires the minimum necessary distance 2 as a distance between reference points in the Y-axis direction.

Similarly, the distance flag of each of strokes L07, L09, L11, L12 and L14 in the Y-axis direction is 2. This indicates that the distance flag of each of strokes L07, L09, L11, L12 and L14 in the Y-axis direction has the minimum necessary distance, and that the distance flag of each of strokes L07, L09, L11, L12 and L14 requires the minimum necessary distance 2 as a distance between reference points in the Y-axis direction.

The distance flag of stroke L15 in the Y-axis direction is 1. This indicates that the distance flag of stroke L15 in the Y-axis direction has the minimum necessary distance, and that the distance flag of stroke L15 requires the minimum necessary distance 1 as a distance between reference points in the Y-axis direction.

The distance flag of each of strokes L01, L04, L05, L06, L09 and L11 through L15 in the X-axis direction is x. This indicates that the distance flag of none of strokes L01, L04, L05, L06, L09 and L11 through L15 in the X-axis direction have the minimum necessary distance.

The distance flag of stroke L02 in the X-axis direction is 3. This indicates that the distance flag of stroke L02 in the X-axis direction has the minimum necessary distance, and that the distance flag of stroke L02 requires the minimum necessary distance 3 as a distance between reference points in the X-axis direction.

The distance flag of each of strokes L03 and L08 in the X-axis direction is 2. This indicates that the distance flag of each of strokes L03 and L08 in the X-axis direction has the minimum necessary distance, and that the distance flag of each of strokes L03 and L08 requires the minimum necessary distance 2 as a distance between reference points in the X-axis direction.

The distance flag of each of strokes L07 and L10 in the X-axis direction is 1. This indicates that the distance flag of each of strokes L07 and L10 in the X-axis direction has the minimum necessary distance, and that the distance flag of each of strokes L07 and L10 requires the minimum necessary distance 1 as a distance between reference points in the X-axis direction.

An omission flag represents whether or not a distance between reference points along a specific axis, which is to be adjusted by grid fitting, can be made zero. When such a distance for adjustment can be 0, the omission flag represents the position of the distance in the order by which distances for adjustment are made zero.

An omission flag may be, for example, x. This indicates that the distance for adjustment cannot be made zero. An omission flag may be, for example, integer N. This indicates that the distance for adjustment can be made zero and that the particular distance is the Nth distance to be made zero.

The omission flag of stroke L01 in the Y-axis direction is x. This indicates that the distance for adjustment cannot be made zero.

Similarly, the omission flag of each of strokes L02 through L08, L10, and L13 through L15 in the Y-axis direction is x. This indicates that the distance for adjustment cannot be made zero.

The omission flag of stroke L09 in the Y-axis direction is 1. This indicates that the distance for adjustment can be made zero and that the particular distance is the first distance to be made zero.

The omission flag of stroke L11 in the Y-axis direction is 2. This indicates that the distance for adjustment can be made zero and that the particular distance is the second distance to be made zero.

The omission flag of stroke L12 in the Y-axis direction is 3. This indicates that the distance for adjustment can be made zero and that the particular distance is the third distance to be made zero.

The omission flag of each of strokes L01 through L15 in the X-axis direction is x. This indicates that the distance for adjustment cannot be made zero.

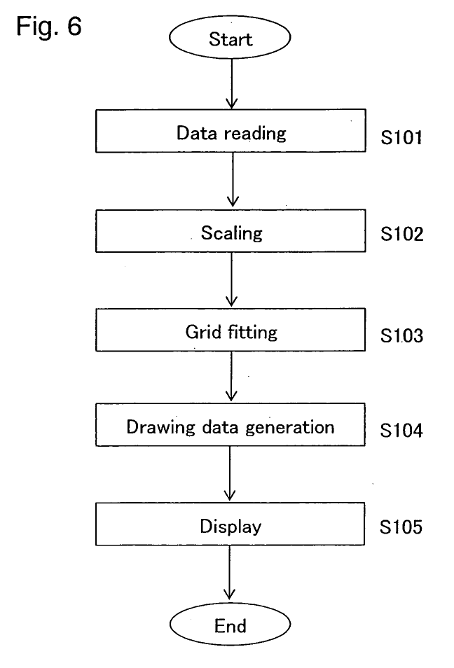

FIG. 6 is a flowchart illustrating a processing procedure of the character display program 141. The character display program 141 is executed by the CPU 121.

Hereinafter, the processing of the character display program 141 will be described step by step.

Step S101: Character information representing a character to be displayed by the display device 130 is input to the main memory 122 through the input device 110. In accordance with the input character information, the CPU 121 reads the character data 142 stored in the assisting memory device 140. The read character data 142 is, for example, the character data 142 shown in FIG. 3. The character data 142 includes coordinate data and data representing reference points.

Step S102: The CPU 121 scales the coordinate data and the data representing the reference points included in the character data 142 in accordance with the character size to be output to the display device 130, and thus generates the scaled coordinate data and the scaled data representing the reference points. The CPU 121 executes the program 141a included in the character display program 141, so that step S102 is performed.

The scaled coordinate data is stored in the main memory 122.

When the character size to be output is n dots, the scaled coordinate data (X, Y) is, for example, ((n−1)×X/255, (n−1)×Y/255).

In the example shown in FIG. 6, step S102 corresponds to the “step of scaling a character or graphic including reference points along a specific axis so as to generate scaled reference points”, but the present invention is not limited to this.

Step S103: The CPU 121 grid-fits the scaled coordinate data, and thus generates grid-fitted coordinate data. The CPU 121 executes the program 141b included in the character display program 141, so that step S103 is performed. The grid-fitted coordinate data is stored in the main memory 122.

The details of the procedure of grid fitting will be described later.

Step S104: The CPU 121 generates drawing data displayable by the display device 130 based on the grid-fitted coordinate data. For example, the CPU 121 generates drawing data from the grid-fitted coordinate data using straight line drawing or curved line drawing such as spline or the like. The CPU 121 executes the program 141c included in the character display program 141, so that step S104 is performed. The generated drawing data is stored in the main memory 122.

Step S105: The CPU 121 displays the drawing data generated in step S104 by the display device 130.

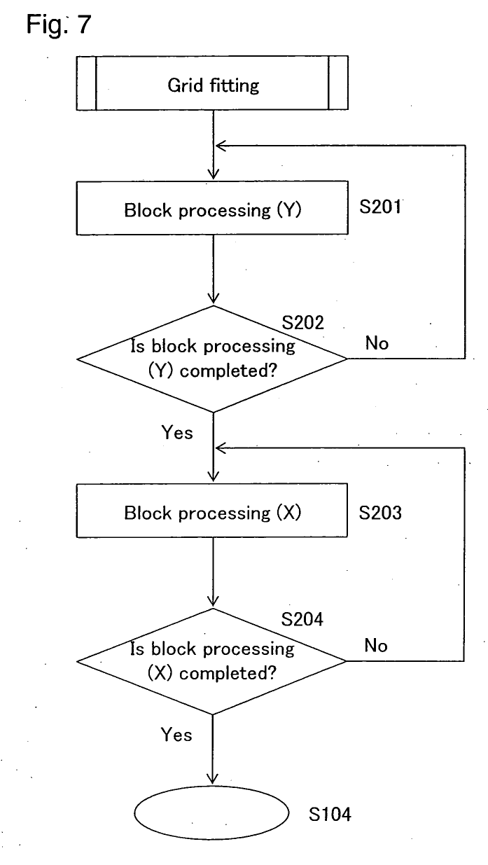

FIG. 7 is a flowchart illustrating a detailed procedure of grid fitting (program 141b) performed in step S103. The program 141b is executed by the CPU 121.

Hereinafter, the detailed procedure of grid fitting (program 141b) performed in step S103 will be described step by step.

Step S201: The CPU 121 processes the blocks in the Y-axis direction in the order of block number.

The details of the procedure of processing blocks in the Y-axis direction performed in step S201 will be described later.

Step S202: The CPU 121 determines whether or not the processing of the blocks in the Y-axis direction has been completed, based on the character data 142.

The CPU 121 performs the determination by, for example, comparing the number of times that step S201 has been repeated with the maximum value of the block numbers in the Y-axis direction.

When the number of times that step S201 has been repeated is equal to the maximum value of the block numbers in the Y-axis direction, the determination in step S202 is “Yes”. In this case, the processing proceeds to step S203.

When the number of times that step S201 has been repeated is smaller than the maximum value of the block numbers in the Y-axis direction, the determination in step S202 is “No”. In this case, the processing goes to step S201.

Step S203: The CPU 121 processes the blocks in the X-axis direction in the order of block number.

The details of the procedure of processing blocks in the X-axis direction performed in step S203 will be described later.

Step S204: The CPU 121 determines whether or not the processing of the blocks in the X-axis direction has been completed, based on the character data 142.

The CPU 121 performs the determination by, for example, comparing the number of times that step S203 has been repeated with the maximum value of the block numbers in the X-axis direction.

When the number of times that step S203 has been repeated is equal to the maximum value of the block numbers in the X-axis direction, the determination in step S204 is “Yes”. In this case, the procedure of grid fitting (program 141b) is terminated.

When the number of times that step S201 has been repeated is smaller than the maximum value of the block numbers in the X-axis direction, the determination in step S204 is “No”. In this case, the processing goes to step S203.

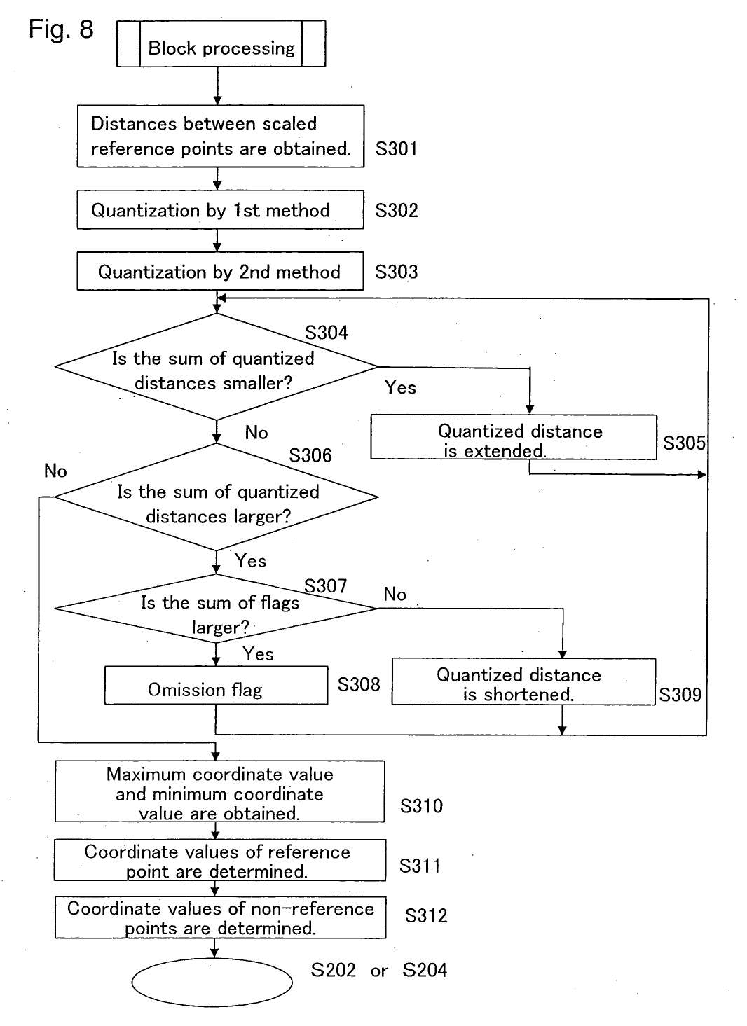

FIG. 8 is a flowchart illustrating a detailed procedure of processing of blocks in the direction of a specific axis performed in steps S201 and S203. The program 141 is executed by the CPU 121.

Hereinafter, the processing of the blocks in the direction of a specific axis performed in steps S201 and S203 will be described step by step.

Step S301: The CPU 121 generates coordinate values of scaled reference points based on the scaled coordinate data. Based on the coordinate value, the CPU 121 obtains distances between the scaled reference points.

Step S302: The CPU 121 obtains a sum of the distances between the scaled reference points. The CPU 121 quantizes the sum of the distances using a first method, and thus generates the sum quantized by the first method.

A sum of the distances between reference points in the Y-axis direction may be found by subtracting the minimum Y coordinate value from the maximum Y coordinate value, among the coordinate values of the scaled reference points.

A sum of the distances between reference points in the X-axis direction may be found by subtracting the minimum X coordinate value from the maximum X coordinate value, among the coordinate values of the scaled reference points.

For example, the CPU 121 uses round-off as a first method for quantizing the sum of the distances.

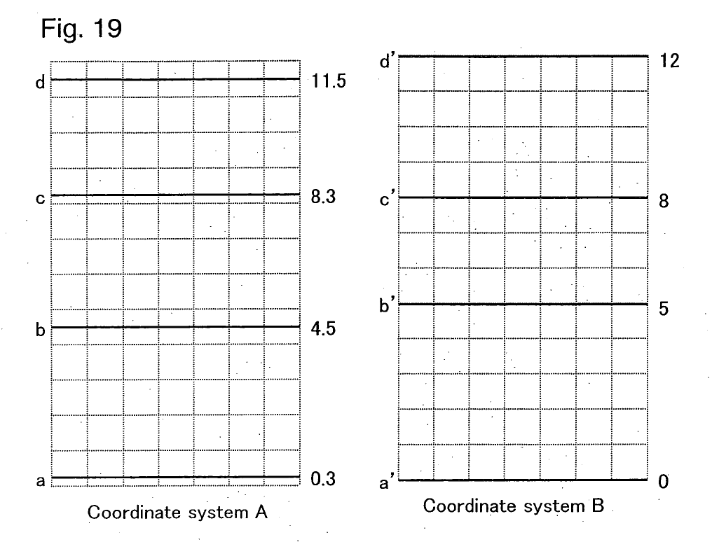

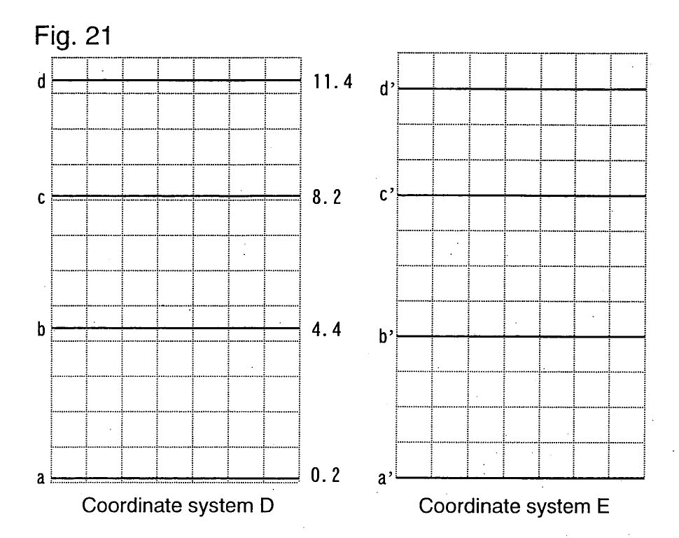

By generating a quantized sum by round-off, the sizes of characters can be uniformized. For example, distance ad in coordinate system A shown in FIG. 19 and distance ad in coordinate system D shown in FIG. 21 are both 11.2. The sum quantized by round-off is 11 in either case.

Round-off is used here as the first method for quantizing the sum of the distances, but the first method is not limited to this. When it is desired that a character appears as large as possible, round-up may be used as the first method for quantizing the sum of the distances. When it is desired that a character appears as small as possible, round-down may be used as the first method for quantizing the sum of the distances. A prescribed threshold value may be used in the first method for quantizing the sum of the distances.

In the example shown in FIG. 8, step S302 corresponds to the “step of quantizing a sum of distances between the scaled reference points by a first method so as to generate a sum quantized by the first method”, but the present invention is not limited to this.

Step S303: The CPU 121 quantizes each of the distances between the scaled reference points by a second method, and thus generates the sum of the distances quantized by the second method. With the second method, the quantization is performed in consideration of the distance flag.

A distance flag represents the minimum necessary distance as a distance quantized by the second method. For example, when the distance between two scaled reference points is 2.4, the distance quantized by round-off is 2 without a distance flag. When the distance flag is 1, the distance quantized by round-off is 1. When the distance flag is 3, however, the distance quantized by round-off is made 3 in consideration of the distance flag.

Round-off is used here as the second method for quantizing the distances, but the second method is not limited to this. As the second method for quantizing the distances, round-up or round-down may be used. A prescribed threshold value may be used.

The first method for quantizing the sum and the second method for quantizing the distances may be the same or different. For example, round-off may be used both as the first method for quantizing the sum and the second for quantizing the distances. When it is desired that a character appears as large as possible, round-up may be used as the first method for quantizing the sum whereas round-off may be used as the second method for quantizing the distances.

In the example shown in FIG. 8, step S303 corresponds to the “step of quantizing the distances between the scaled reference points by a second method so as to generate distances quantized by the second method”, but the present invention is not limited to this.

Step S304: The CPU 121 determines whether or not the sum of the distances quantized by the second method is smaller than the sum quantized by the first method. When the determination in step S304 is “Yes”, the processing proceeds to step S305. When the determination in step S304 is “No”, the processing proceeds to step S306.

Step S305: The CPU 121 extends the distance, an quantization error of which is largest, among the distances quantized by the second method. Since a distance, an quantization error of which is larger, is extended with priority, the order of the size of the distances is not inverted before and after the quantization. The processing goes to step S304. The processing in step S305 may be performed in consideration of a distance flag. For example, a distance having a larger value of distance flag may be extended with priority.

Step S306: The CPU 121 determines whether or not the sum of the distances quantized by the second method is larger than the sum quantized by the first method. When the determination in step S306 is “Yes ”, the processing proceeds to step S307. When the determination in step S306 is “No”, the processing proceeds to step S310.

Step S307: The CPU 121 determines whether or not the sum of the distance flags is larger than the sum quantized by the first method. When the determination in step S307 is “Yes”, the processing proceeds to step S308. When the determination in step S307 is “No”, the processing proceeds to step S309.

Step S308: An omission flag is considered to make the distances quantized by the second method zero. Then, the processing goes to step S304.

In step S308, strokes may be omitted in consideration of the omission flag. Making the distances quantized by the second method zero is equivalent to omitting strokes.

Step S309: The CPU 121 shortens the distance, an quantization error of which is largest, among the distances quantized by the second method. Since a distance, an quantization error of which is larger is shortened with priority, the order of the size of the distances is not inverted before and after the quantization. The processing goes to step S304. The processing in step S309 may be performed in consideration of a distance flag. For example, a distance with no distance flag or with a small value of distance flag may be shortened with priority.

In the example shown in FIG. 8, step S305, S308 or S309 corresponds to the “step of adjusting at least one of the distances quantized by the second method such that a sum of the distances quantized by the second method equals the sum quantized by the first method”, but the present invention is not limited to this.

Step S310: The maximum coordinate value and the minimum coordinate value of a block forming the character are determined. Specifically, the quantization error generated as a result of rounding off the maximum coordinate value of the scaled reference points is compared with the quantization error generated as a result of rounding off the minimum coordinate value of the scaled reference points. Based on the coordinate error with a smaller quantization error, the coordinate values of the block are determined. The size of the block forming the character is the sum quantized by the first method.

For example, when the quantization error generated as a result of rounding off the maximum coordinate value of the scaled -reference points is smaller than the quantization error generated as a result of rounding off the minimum coordinate value of the scaled reference points, the maximum coordinate value of the scaled reference points is the maximum coordinate value of the block. The minimum coordinate value of the block is obtained by subtracting the sum quantized by the first method, which is the size of the block forming the character, from the maximum coordinate value of the block.

For example, when the quantization error generated as a result of rounding off the minimum coordinate value of the scaled reference points is smaller than the quantization error generated as a result of rounding off the maximum coordinate value of the scaled reference points, the minimum coordinate value of the scaled reference points is the minimum coordinate value of the block. The maximum coordinate value of the block is obtained by adding the sum quantized by the first method, which is the size of the block forming the character, to the minimum coordinate value of the block.

Step S311: The coordinate values of the reference points after grid-fitting are obtained based on the maximum coordinate value of the block forming the character, the minimum coordinate value of the block forming the character, and the distances quantized by the second method.

Step S312: The coordinate values of non-reference points are determined. A prescribed point on a scaled character is determined such that the value of distance a/distance b is closest to the value of distance A/distance B. Here, a point which is on a pre-scaled character and corresponds to the prescribed point to be determined is between a first reference point and a second reference point adjacent to each other, among pre-scaled reference points. Distance A is a distance between the point on the pre-scaled character and the first reference point. Distance B is a distance between the point on the pre-scaled character and the second reference point. Distance a is a distance between the prescribed point to be determined and the scaled first reference point. Distance b is a distance between the prescribed point to be determined and the scaled second reference point.

In the example shown in FIGS. 6 and 8, steps S310, S311, S312, S104 and S105 correspond to the “step of displaying the scaled character or graphic based on the scaled reference points accompanying the at least one adjusted distance”, but the present invention is not limited to this.

In the example shown in FIGS. 6 and 8, steps S102, S104, S105, S302, S303, S305 and S308 through S312 correspond to the “character/graphic display processing”, but the present invention is not limited to this.

The control section 120 including the CPU 121 executes character/graphic display processing, but the present invention is not limited to this.

In the above-described example, a character is scaled and the scaled character is displayed. The present invention is not limited to this. The present invention is applicable to scaling a graphic and displaying the scaled graphic instead of, or in addition to, a character. In this case, a graphic display program is usable instead of, or in addition to, the character display program 141. Graphic data is usable instead of, or in addition to, the character data 142. The graphic display program may also include substantially the same steps as those of the character display program 141. The graphic data may include at least one reference point, like the character data.

According to a character/graphic display apparatus of the present invention, at least one of the distances quantized by the second method is adjusted, such that the sum of the distances quantized by the second method is equal to the sum quantized by the first method. When the sum of the distances quantized by the second method is larger than the sum quantized by the first method, adjustment is performed such that at least one of the distances quantized by the second method is shortened. When the sum of the distances quantized by the second method is smaller than the sum quantized by the first method, adjustment is performed such that at least one of the distances quantized by the second method is extended. As a result, the sum of the distances quantized by the second method becomes equal to the sum quantized by the first method. Thus, the shape and size of the character and/or graphic after the adjustment of positions can be the same as those before the adjustment. Since the order of the size of the distances quantized by the second method is not inverted, the balance of the character and/or graphic displayed by the display device 130 can be maintained.

According to the character/graphic display apparatus of the present invention, at least one of the distances quantized by the second method is adjusted in consideration of a flag representing the minimum necessary distance as a distance quantized by the second method. Accordingly, the distance quantized by the second method can keep the minimum necessary distance. As a result, a character and/or graphic is prevented from being crushed when displayed by the display device 130.

As a specific example, the processing procedure of the character display program 141 for displaying character [symbol] with the size of 30 dots will be described.

Step S101: Character information representing the character [symbol] to be displayed by the display device 130 is input to the main memory 122 through the input device 110. In accordance with the input character information, the CPU 121 reads the character data 142 stored in the assisting memory device 140. The read character data 142 is, for example, the character data 142 shown in FIG. 3. The character data 142 includes coordinate data.

Step S102: The CPU 121 scales the coordinate data included in the character data 142 in accordance with the character size (30 dots) to be output to the display device 130, and thus generates the scaled coordinate data. The scaled coordinate data (X, Y) is ((30−1)×X/255, (30−1)×Y/255). The scaled coordinate data is calculated down to the second decimal place.

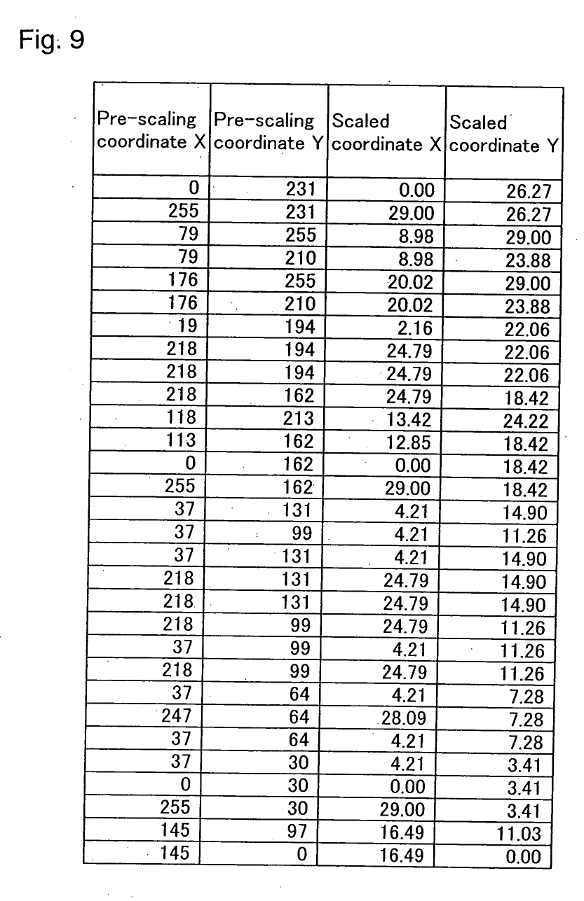

FIG. 9 shows pre-scaling coordinate data and post-scaling coordinate data.

Step S103: The CPU 121 grid-fits the scaled coordinate data, and thus generates grid-fitted coordinate data.

Hereinafter, the procedure of grid fitting performed in step S103 (program 141b) will be described step by step.

Step S201: The CPU 121 processes the block in the Y-axis direction for the stroke having block number 1 in the Y-axis direction.

Hereinafter, the processing of the blocks in the Y-axis direction performed in steps S201 will be described step by step.

Step S301: The CPU 121 generates coordinate values of scaled reference points based on the scaled coordinate data. Based on the coordinate value, the CPU 121 obtains distances between the scaled reference points. There are eight distances between reference points. The first distance having distance number Y1 is 2.73. The second distance having distance number Y2 is 4.21. The third distance having distance number Y3 is 3.64. The fourth distance having distance number Y4 is 3.52. The fifth distance having distance number Y5 is 3.64. The sixth distance having distance number Y6 is 3.98. The seventh distance having distance number Y7 is 3.87. The eighth distance having distance number Y8 is 3.41.

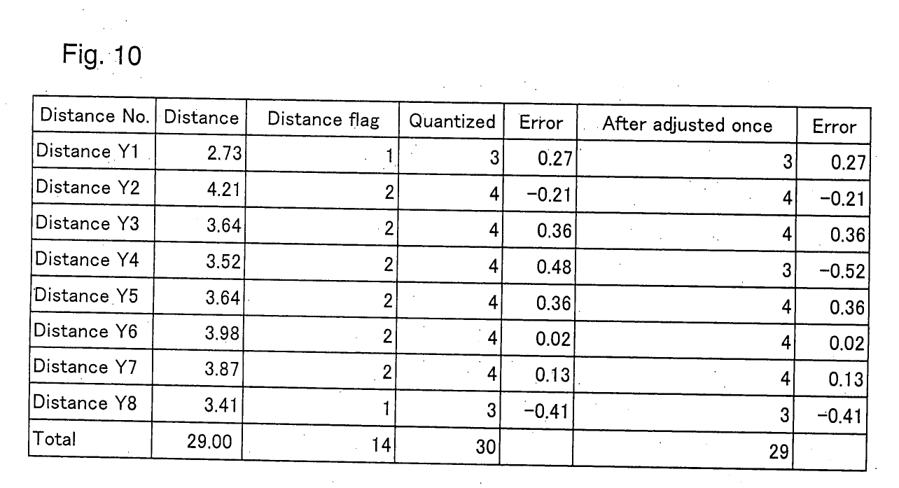

FIG. 10 shows data obtained by grid-fitting the character data in the Y-axis direction.

These eight distances are shown under “distance” in FIG. 10.

Step S302: The CPU 121 obtains the sum of distances Y1 through Y8. The sum of the distances is 29.00. The CPU 121 quantizes the sum by round-off. The sum quantized by round-off is 29.

Step S303: The CPU 121 quantizes each of distances Y1 through Y8 by round-off in consideration of the distance flag. Each of the distances quantized by round-off is shown under “quantized” in FIG. 10.

Step S304: The CPU 121 determines whether or not the sum of the distances quantized by round-off is smaller than the sum quantized by round-off. The sum of the distances quantized by round-off is 30, and the sum quantized by round-off is 29. Accordingly, the determination in step S304 is “No”, and the processing proceeds to step S306.

Step S306: The CPU 121 determines whether or not the sum of the distances quantized by round-off is larger than the sum quantized by round-off. The determination in step S306 is “Yes”, and the processing proceeds to step S307.

Step S307: The CPU 121 determines whether or not the sum of the distance flags is larger than the sum quantized by round-off. The sum of the distance flags is 14. Since the sum of the distance flags is not larger than the sum quantized by round-off, the determination in step S307 is “No”, and the processing proceeds to step S309.

Step S309: The CPU 121 shortens the distance, an quantization error of which is largest, among the distances quantized by the second method. With reference to FIG. 10, the quantization error of distance Y4 is largest. Therefore, the value 4 of the distance Y4 is adjusted to 3. The processing goes to step S304.

Here, the sum of the distances quantized by round-off is 29, which is equal to the sum quantized by round-off. Accordingly, the processing proceeds to step S310 from S304 via step S306.

Step S310: The maximum coordinate value and the minimum coordinate value in the Y-axis direction of the block forming the character [symbol] are determined. The maximum coordinate value in the Y-axis direction of the block is 29. The minimum coordinate value in the Y-axis direction of the block is 0.

Step S311: The Y coordinate values of the reference points after grid-fitting are is obtained. Since the value of distance Y3 is 3, the Y coordinate value of the reference point determining distance Y1 is 29−3=26. The other reference points are determined in substantially the same manner.

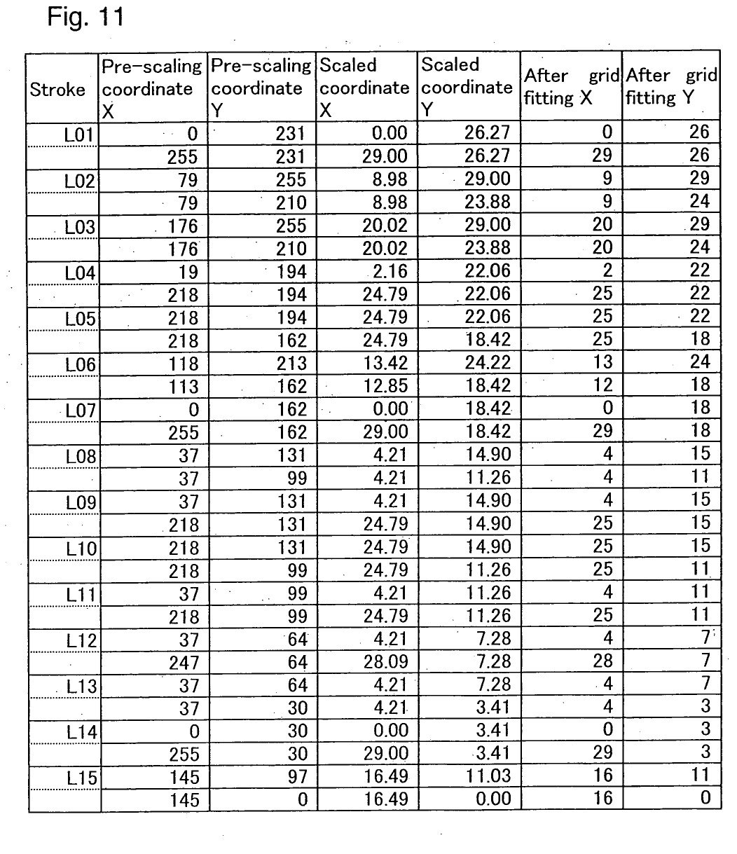

Step S312: The coordinate values of non-reference points are determined. FIG. 11 shows coordinate values after grid fitting.

Since the processing of the block having block number 1 in the Y-axis direction is completed, the processing proceeds to step S202.

Step S202: The number of times that step S201 has been repeated (once) is equal to the maximum value of the block number in the Y-axis direction (1). Therefore, it is determined that the processing in the Y-axis direction is completed. The processing proceeds to step S203.

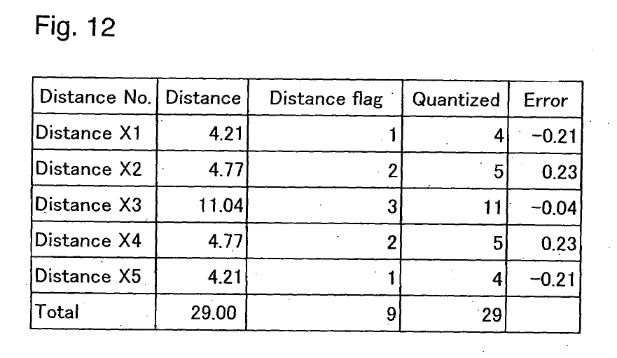

Step S203: The processing of the block having block number 1 in the X-axis direction is performed. As described above, substantially the same processing as for the block having block number 1 in the Y-axis direction is performed. FIG. 12 shows data obtained by grid-fitting the character data in the X-axis direction.

Step S204: The number of times that step S203 has been repeated (once) is equal to the maximum value of the block number in the X-axis direction (1). Therefore, it is determined that the processing in the X-axis direction is completed. The processing of grid-fitting is completed.

Step S104: Drawing data is generated.

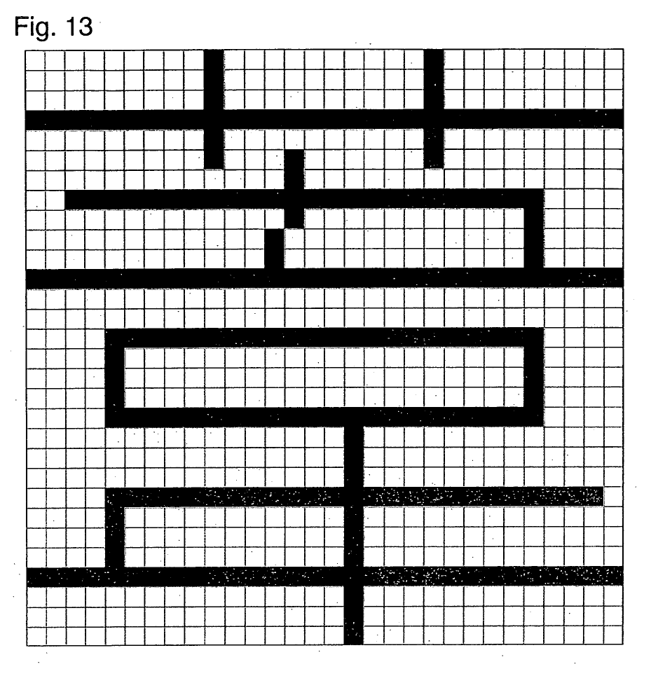

Step S105: The CPU 121 displays the drawing data generated in step S104 by the display device 130. FIG. 13 shows character [symbol] of the size of 30 dots displayed by the display device 130.

As a specific example, the processing procedure of the character display program 141 for displaying character [symbol] with the size of 14 dots will be described.

Step S101: Character information representing the character [symbol] to be displayed by the display device 130 is input to the main memory 122 through the input device 110. In accordance with the input character information, the CPU 121 reads the character data 142 stored in the assisting memory device 140. The read character data 142 is, for example, the character data 142 shown in FIG. 3. The character data 142 includes coordinate data.

Step S102: The CPU 121 scales the coordinate data included in the character data 142 in accordance with the character size (14 dots) to be output to the display device 130, and thus generates the scaled coordinate data. The scaled coordinate data (X, Y) is ((14−1)×X/255, (14−1)×Y/255). The scaled coordinate data is calculated down to the second decimal place.

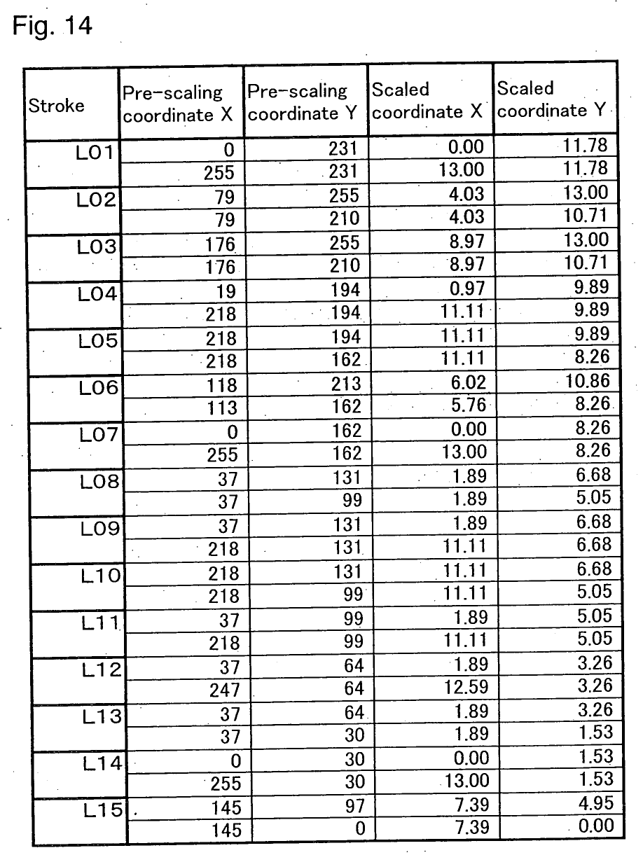

FIG. 14 shows pre-scaling coordinate data and post-scaling coordinate data.

Step S103: The CPU 121 grid-fits the scaled coordinate data, and thus generates grid-fitted coordinate data.

Hereinafter, the procedure of grid fitting performed in step S103 (program 141b) will be described step by step.

Step S201: The CPU 121 processes the block in the Y-axis direction for the stroke having block number 1 in the Y-axis direction.

Hereinafter, the processing of the blocks in the Y-axis direction performed in steps S201 will be described step by step.

Step S301: The CPU 121 generates coordinate values of scaled reference points based on the scaled coordinate data. Based on the coordinate value, the CPU 121 obtains distances between the scaled reference points. There are eight distances between reference points. The first distance having distance number y1 is 1.22. The second distance having distance number y2 is 1.89. The third distance having distance number y3 is 1.63. The fourth distance having distance number y4 is 1.58. The fifth distance having distance number y5 is 1.63. The sixth distance having distance number y6 is 1.79. The seventh distance having distance number y7 is 1.73. The eighth distance having distance number y8 is 1.53.

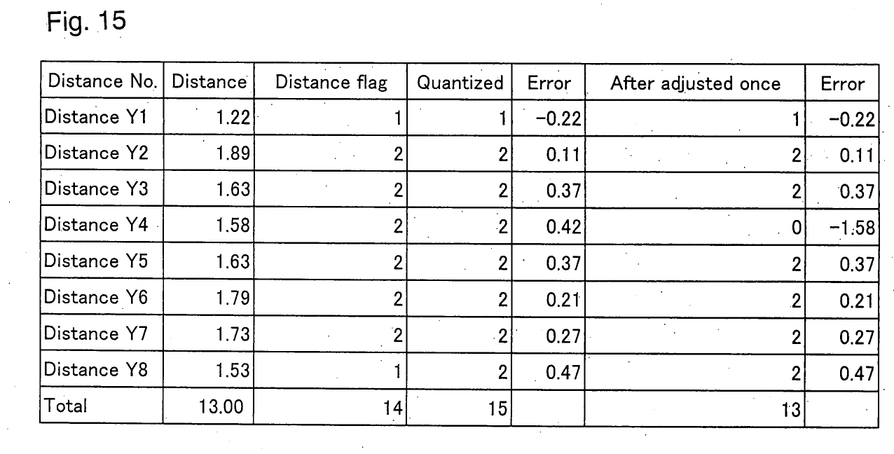

FIG. 15 shows data obtained by grid-fitting the character data in the Y-axis direction.

These eight distances are shown under “distance” in FIG. 13.

Step S302: The CPU 121 obtains the sum of distances y1 through y8. The sum of the distances is 13.00. The CPU 121 quantizes the sum by round-off. The sum quantized by round-off is 13.

Step S303: The CPU 121 quantizes each of distances y1 through 78 by round-off in consideration of the distance flag. Each of the distances quantized by round-off is shown under “quantized” in FIG. 15.

Step S304: The CPU 121 determines whether or not the sum of the distances quantized by round-off is smaller than the sum quantized by round-off. The sum of the distances quantized by round-off is 13, and the sum quantized by round-off is 15. Accordingly, the determination in step S304 is “No ”, and the processing proceeds to step S306.

Step S306: The CPU 121 determines whether or not the sum of the distances quantized by round-off is larger than the sum quantized by round-off. The determination in step S306 is “Yes”, and the processing proceeds to step S307.

Step S307: The CPU 121 determines whether or not the sum of the distance flags is larger than the sum quantized by round-off. The sum of the distance flags is 14. Since the sum of the distance flags is larger than the sum quantized by round-off, the determination in step S307 is “Yes”, and the processing proceeds to step S308.

Step S308: The CPU 121 considers an omission flag to make distance y4 quantized by round-off zero. The processing goes to step S304.

Here, the sum of the distances quantized by round-off is 13, which is equal to the sum quantized by round-off. Accordingly, the processing proceeds to step S310 from S304 via step S306.

Step S310: The maximum coordinate value and the minimum coordinate value in the Y-axis direction of the block forming the character [symbol] are determined. The maximum coordinate value in the Y-axis direction of the block is 13. The minimum coordinate value in the Y-axis direction of the block is 0.

Step S311: The Y coordinate values of the reference points after grid-fitting are is obtained. Since the value of distance y1 is 1, the Y coordinate value of the reference point determining distance y1 is 13−1=25. The other reference points are determined in substantially the same manner.

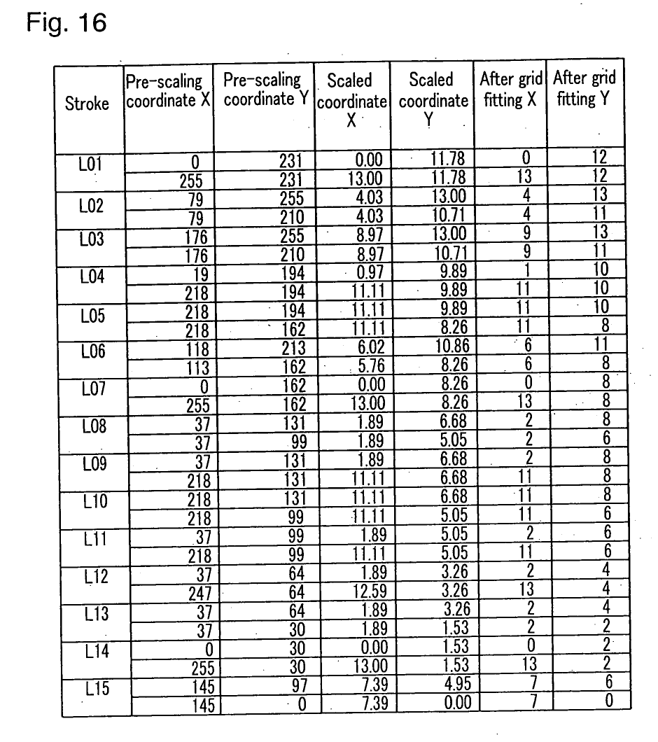

Step S312: The coordinate values of non-reference points are determined. FIG. 16 shows coordinate values after grid fitting.

Since the processing of the block having block number 1 in the Y-axis direction is completed, the processing proceeds to step S202.

Step S202: The number of times that step S201 has been repeated (once) is equal to the maximum value of the block number in the Y-axis direction (1). Therefore, it is determined that the processing in the Y-axis direction is completed. The processing proceeds to step S203.

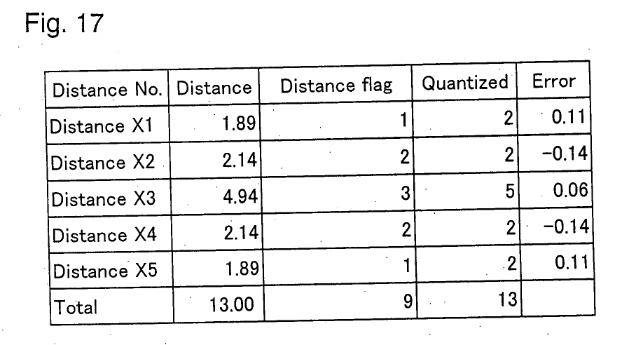

Step S203: The processing of the block having block number 1 in the X-axis direction is performed. As described above, substantially the same processing as for the block having block number 1 in the Y-axis direction is performed. FIG. 17 shows data obtained by grid-fitting the character data in the X-axis direction.

Step S204: The number of times that step S203 has been repeated (once) is equal to the maximum value of the block number in the X-axis direction (1). Therefore, it is determined that the processing in the X-axis direction is completed. The processing of grid-fitting is completed.

Step S104: Drawing data is generated.

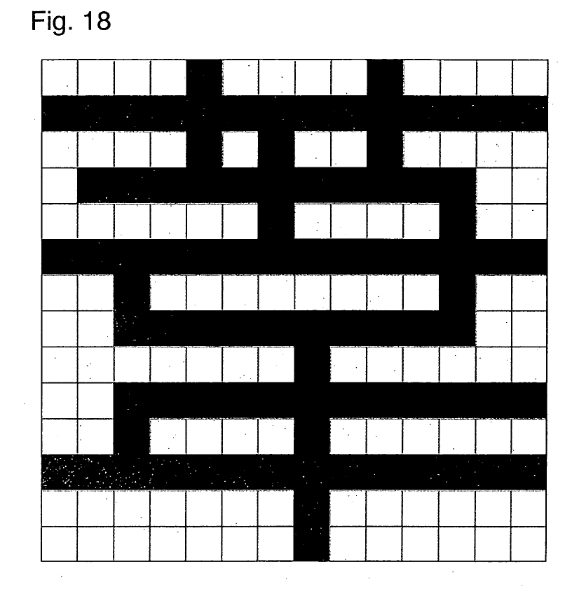

Step S105: The CPU 121 displays the drawing data generated in step S104 by the display device 130. FIG. 18 shows character [symbol] of the size of 14 dots displayed by the display device 130.

The present invention has been described by way of preferable examples thereof. It is not intended that the present invention is limited to these examples. It is understood that the scope of the present invention is construed as being only limited by the claims. It is understood that those skilled in the art can work the equivalents of the present invention based on the description of the present invention and the technological common knowledge. The patents, patent applications and documents referred to in this specification are herein incorporated by reference and construed as being specifically described in this specification.

### INDUSTRIAL APPLICABILITY

According to a character/graphic display apparatus of the present invention, at least one of the distances quantized by the second method is adjusted, such that the sum of the distances quantized by the second method is equal to the sum quantized by the first method. When the sum of the distances quantized by the second method is larger than the sum quantized by the first method, adjustment is performed such that at least one of the distances quantized by the second method is shortened. When the sum of the distances quantized by the second method is smaller than the sum quantized by the first method, adjustment is performed such that at least one of the distances quantized by the second method is extended. As a result, the sum of the distances quantized by the second method becomes equal to the sum quantized by the first method. Thus, the shape and size of the character and/or graphic after the adjustment of positions can be the same as those before the adjustment. Since the order of the size of the distances quantized by the second method is not inverted, the balance of the character and/or graphic displayed by the display device can be maintained.

According to the character/graphic display apparatus of the present invention, at least one of the distances quantized by the second method is adjusted in consideration of a flag representing the minimum necessary distance as a distance quantized by the second method. Accordingly, the distance quantized by the second method can keep the minimum necessary distance. As a result, a character and/or graphic is prevented from being crushed when displayed by the display device.

1-12. (canceled)

13. A character/graphic display apparatus, comprising:
a display device for displaying a character or graphic; and
a control section for controlling the display device;
wherein:
the control section executes character/graphic display processing; and
the character/graphic display processing includes the steps of:
(a) scaling a character or graphic including reference points along a specific axis so as to generate scaled reference points;
(b) quantizing a sum of distances between the scaled reference points by a first method so as to generate a sum quantized by the first method;
(c) quantizing the distances between the scaled reference points by a second method so as to generate distances quantized by the second method;
(d) adjusting at least one of the distances quantized by the second method such that a sum of the distances quantized by the second method equals the sum quantized by the first method; and
(e) displaying the scaled character or graphic based on the scaled reference points accompanying the at least one adjusted distance.

14. A character/graphic display apparatus according to claim 13, wherein the quantization by the second method is performed in consideration of a distance flag representing a minimum necessary distance as a distance quantized by the second method.

15. A character/graphic display apparatus according to claim 13, wherein step (d) is performed in consideration of a distance flag representing a minimum necessary distance as a distance quantized by the second method.

16. A character/graphic display apparatus according to claim 13, wherein step (d) includes the step of adjusting a distance having a larger quantization error caused by the second method with priority, among the distances quantized by the second method.

17. A character/graphic display apparatus according to claim 13, wherein step (d) includes the step of extending at least one of the distances quantized by the second method.

18. A character/graphic display apparatus according to claim 13, wherein step (d) includes the step of shortening at least one of the distances quantized by the second method.

19. A character/graphic display apparatus according to claim 13, wherein step (d) includes the step of making at least one of the distances quantized by the second method zero.

20. A character/graphic display apparatus according to claim 13, wherein step (e) includes the step of displaying a first point which is a prescribed point on the scaled character, such that a value of distance a/distance b is closest to a value of distance A/distance B, where:
a second point which corresponds to the first point and is on the pre-scaling character is between a first reference point and a second reference point adjacent to each other, among the pre-scaling reference points;
distance A is a distance between the second point and the first reference point;
distance B is a distance between the second point and the second reference point;
distance a is between the first point and the scaled first reference point; and
distance b is between the first point and the scaled second reference point.

21. A character/graphic display apparatus according to claim 13, wherein:
the character is formed of a plurality of blocks; and
the character/graphic display processing further includes the step of executing steps (b) through (d) for each of the plurality of blocks.

22. A character/graphic display apparatus according to claim 19, wherein the step of making at least one of the distances quantized by the second method zero is performed in consideration of a flag which represents a position of a distance to be made zero in the order by which the at least one of the distances is made zero.

23. A character/graphic display method, comprising the steps of:
scaling a character or graphic including reference points along a specific axis so as to generate scaled reference points;
quantizing a sum of distances between the scaled reference points by a first method so as to generate a sum quantized by the first method;
quantizing the distances between the scaled reference points by a second method so as to generate distances quantized by the second method;
adjusting at least one of the distances quantized by the second method such that a sum of the distances quantized by the second method equals the sum quantized by the first method; and
displaying the scaled character or graphic based on the scaled reference points accompanying the at least one adjusted distance.

24. A program for having a character/graphic display apparatus, including a display device for displaying a character or graphic an a controlling section for controlling the display device, to execute character/graphic display processing, the character/graphic display processing includes the steps of:
scaling a character or graphic including reference points along a specific axis so as to generate scaled reference points;
quantizing a sum of distances between the scaled reference points by a first method so as to generate a sum quantized by the first method;
quantizing the distances between the scaled reference points by a second method so as to generate distances quantized by the second method;
adjusting at least one of the distances quantized by the second method such that a sum of the distances quantized by the second method equals the sum quantized by the first method; and
displaying the scaled character or graphic based on the scaled reference points accompanying the at least one adjusted distance.

25. A recording medium readable by a character/graphic display apparatus, including a display device for displaying a character or graphic and a controlling section for controlling the display device, the recording medium has a program for having the control section to execute character/graphic display processing which includes the steps of:
scaling a character or graphic including reference points along a specific axis so as to generate scaled reference points;
quantizing a sum of distances between the scaled reference points by a first method so as to generate a sum quantized by the first method;
quantizing the distances between the scaled reference points by a second method so as to generate distances quantized by the second method;
adjusting at least one of the distances quantized by the second method such that a sum of the distances quantized by the second method equals the sum quantized by the first method; and
displaying the scaled character or graphic based on the scaled reference points accompanying the at least one adjusted distance.
